(19) United States
(12) Patent Application Publication
(10) Pub. No.: US 2007/0215409 A1
(43) Pub. Date: Sep. 20, 2007

(54) APPARATUS FOR ESCAPING AREA OF ACCIDENT

(75) Inventors: ROBERT BOSCHER, DRAYTON VALLEY (CA); PAUL R. SMITH, DRAYTON VALLEY (CA); DARRELL R. BOULTER, DRAYTON VALLEY (CA)

Correspondence Address: BROUSE MCDOWELL LPA, 388 SOUTH MAIN STREET, SUITE 500, AKRON, OH, 44311, US

(73) Assignees: ROBERT BOSCHER, DRAYTON VALLEY (CA); PAUL SMITH, DRAYTON VALLEY (CA); DARRELL R BOULTER, DRAYTON VALLEY (CA); ALLAN SAWIN, EDMONTON (CA); MATHEW BALDWIN, EDMONTON (CA)

(21) Appl. No.: 11/687,145

(22) Filed: Mar. 16, 2007

(30) Foreign Application Priority Data
Mar. 16, 2006 (CA) 2539883

(51) Int. Cl. A62B 1/16

(52) U.S. Cl. 182/3

(57) ABSTRACT

An apparatus for escaping the area of an accident on a drilling rig platform or the like is disclosed. A frame defines an interior space sized to accommodate a worker. A locking system includes a locking mechanism and also a foot-actuated disengager that is located at least proximate to the bottom of the frame. The locking mechanism is adapted to interlock with a mating portion on the platform to prevent the frame from travel away from the platform when the locking mechanism engages the mating portion. The disengager is connected to the locking mechanism and has a foot receiving surface region upon which force can be applied to displace the disengager between a first, engaged position and a second position to disengage the locking mechanism from the mating portion. The frame will travel away from the platform to the terminal location under gravity when the locking mechanism is disengaged.

### FIELD

This application claims priority to Canadian patent application No. 2,539,883, filed Mar. 16, 2006, entitled Apparatus For Escaping Area of Accident. The present application relates to apparatus for escaping the area of an accident and, in particular, to cable-suspended apparatus for emergency escape from a platform on a rig.

### BACKGROUND

Often it is necessary to have someone working on a rig platform (such as a derrick tubing board, for example). Sometimes however, rig workers on such platforms are faced with a blowout or some other kind of accident and need to escape quickly from the platform in order to avoid being seriously or fatally injured. Various t-bar or chair-based systems exist for providing a means for escaping from such platforms; however a difficulty encountered with known escape systems is that functionally impaired workers (e.g. workers who are in a state of shock as a result of the accident, or workers who have been burned or disoriented by gases as a result of the accident) can have difficulties in accessing and operating them.

Accordingly, it would be advantageous to improve systems and devices for escaping accident areas.

### SUMMARY OF THE DISCLOSURE

According to one example embodiment, an apparatus is provided for emergency escape from a drilling rig platform along a path defined by at least one cable extending between the platform and a remote, terminal location. The apparatus includes a frame in which a top of the frame is located above a bottom of the frame when the frame is erect. The frame defines an interior space large enough to accommodate a worker. A locking system includes a locking mechanism and also a foot-actuated disengager that is located at least proximate to the bottom of the frame. The locking mechanism is adapted to interlock with a mating portion on the platform to prevent the frame from travel away from the platform when the locking mechanism engages the mating portion. The disengager is connected to the locking mechanism and has a foot receiving surface region upon which force can be applied to displace the disengager between a first, engaged position and a second position to disengage the locking mechanism from the mating portion. The frame will travel away from the platform to the terminal location under gravity when the locking mechanism is disengaged.

According to another example embodiment there is provided an apparatus for emergency escape from such a platform along a path defined by at least one cable extending between the platform and a remote, terminal location. The apparatus includes a frame in which a top of the frame is positioned above a bottom of the frame when the frame is erect. The frame defines an interior space sized to accommodate at least one adult male. A locking means is adapted to interlock with mating means on the platform to prevent the frame from travel away from the platform when the locking means engages the mating means. A foot-actuated disengagement means is located at least proximate the bottom of the frame and is connected to the locking means. It has a foot receiving surface region upon which force can be applied to displace the foot-actuated disengagement means from a first, engaged position and a second position to disengage the locking means from the mating means. The frame will travel away from the platform to the terminal location under gravity when the locking means is disengaged.

According to one aspect of the invention, an apparatus for escaping the area of an accident on a drilling rig platform or the like is disclosed. Emergency escape from the platform is along a path defined by at least one cable extending between the platform and a remote, terminal location. The apparatus includes a frame in which a top of the frame is located above a bottom of the frame when the frame is erect. The frame defines an interior space sized to accommodate a worker. A locking system includes a locking mechanism and also a foot-actuated disengager that is located at least proximate to the bottom of the frame. The locking mechanism is adapted to interlock with a mating portion on the platform to prevent the frame from travel away from the platform when the locking mechanism engages the mating portion. The disengager is connected to the locking mechanism and has a foot receiving surface region upon which force can be applied to displace the disengager between a first, engaged position and a second position to disengage the locking mechanism from the mating portion. The frame will travel away from the platform to the terminal location under gravity when the locking mechanism is disengaged.

### BRIEF DESCRIPTION OF THE DRAWINGS

Reference will now be made, by way of example, to the accompanying drawings which show example embodiments of the present invention, and in which:

FIG. 1 is a perspective view of a trolley constructed in accordance with an example embodiment of the invention, the trolley secured in position next to a platform;

FIG. 2 is a side elevational view of the trolley of FIG. 1;

FIG. 3 is a first end view of the trolley of FIG. 1, a worker shown standing within the trolley; and,

FIG. 4 is an opposite end view of the trolley of FIG. 1.

Similar reference numerals may have been used in different figures to denote similar components.

### DESCRIPTION OF EXAMPLE EMBODIMENTS

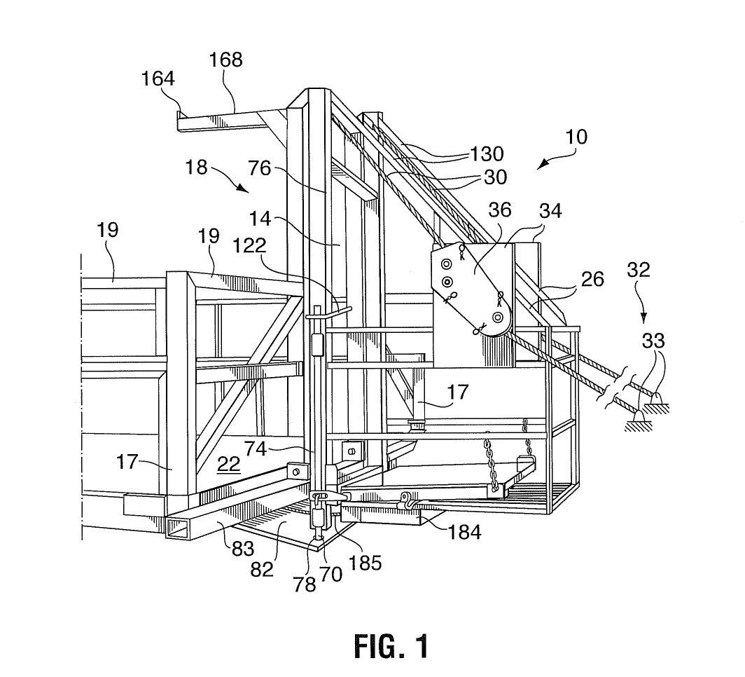

FIG. 1 illustrates an escape apparatus that includes a trolley 10 that is secured in position next to a platform 18 and, in particular, next to an egress 14 defined by the platform 18. In at least some embodiments, the platform 18 is at an elevated location on a rig of the type used for drilling or servicing of wells, for example. It will be understood that workers carrying out tasks in relation to the drilling or servicing operation are able to stand on floor 22 of the platform 18 in order to carry out work at the location of the platform 18. Extending vertically upwards from the floor 22 is a plurality of posts 17. Extending between top ends of the posts 17 are handrails 19 which can be grasped by a rig worker. The platform 18 shown in FIG. 1 is a derrick tubing board; however those skilled in the art will appreciate that at least some example embodiments of the escape apparatus disclosed herein are suitable for use in conjunction with other types of platforms such as a racking board, for example. Although the egress 14 shown in FIG. 1 is located at the rear center of the platform 18, in some example embodiments the egress will be located at a different location, such as either rear corner, for example.

The trolley 10 is a rigid structure designed for providing a vehicle for a rig worker to escape from the platform 18 in the case of an accident such as a blowout or the like. In at least some embodiments, the trolley 10 comprises a metal frame 26 composed of a plurality of metal members that define an interior space of the trolley 10 to accommodate one or more workers. As will be appreciated by those skilled in the art, adjacent metal members of the frame 26 can be attached to each other by suitable means such as by welding or bolting, for example. One or more metal members may be liftable or removable. For instance, an optional liftable or removable bar 29 (FIG. 4) can be moved out of the way when a worker 134 enters or exits the trolley 10, and then put back in place once he has entered or exited as the case may be. Alternative displaceable barriers to the illustrated removable bar 29 are contemplated. For example, two short bars hingedly attached and perpendicularly extending out from opposite sides of the egress 14 could be employed. These two bars would be attached to the frame 26 at roughly the same height and would each extend out slightly less than half the distance across the egress 14. Furthermore, the two bars would swing inwardly once pressed upon by a worker entering the trolley 10 through the egress 14.

In some example embodiments, the frame 26 is made of aluminum, and in some examples the trolley 10 weighs between 80 and 120 kg (176 to 224 lbs). In some examples, known bonding means can be implemented to reduce the ability of the frame 26 to act as a transmitter of static electric charge. Also, although the trolley 10 will typically be a metal trolley, it will be understood that the trolley could at least in part be made of some other material such as graphite, for example. Although not illustrated, in some examples the trolley 10 includes one or more vertical walls/barriers which, for example, can serve to keep the hands or feet of a rig worker inside the trolley 10.

A rig worker standing on the floor 22 of the platform 18 can enter the trolley 10 by exiting the platform 18 through the egress 14 to enter the interior space of the trolley 10. This interior space is at least sufficiently large to accommodate one worker; however in some examples the interior space is sufficiently large to accommodate two or more people. Because in at least some embodiments it is acceptable if the head of the rig worker sticks out above the top boundary of the interior space defined by the trolley frame, it will be understood that the upper metal members of the trolley frame need not necessarily be a particular minimum height above the base of the frame. For instance, the illustrated frame 26 defines an interior space that will accommodate the worker 134 even though his head will stick out above upper metal members 130 of the frame 26.

To protect a rig worker from an accidental fall off of a rig platform, it is typical for a number of lanyards to be employed wherein one end of each of the lanyards is connected to the worker, and the other end of each of the lanyards is connected to the rig platform upon which the worker intends to carry out work. In the illustrated setup, two similar purpose lanyards are employed: a lanyard 138 (sometimes referred to as the working lanyard) and a lanyard 140 (sometimes referred to as the overhead fall arrest). It will be understood that in the conventional case where the rig worker needs to escape from the platform, the worker would need to disconnect lanyards that would otherwise prevent the rig worker from distancing himself from the platform. The disconnection steps that the worker would need to take would add to the duration of the time it takes the worker to escape, as well as the complexity of the escape process for the worker.

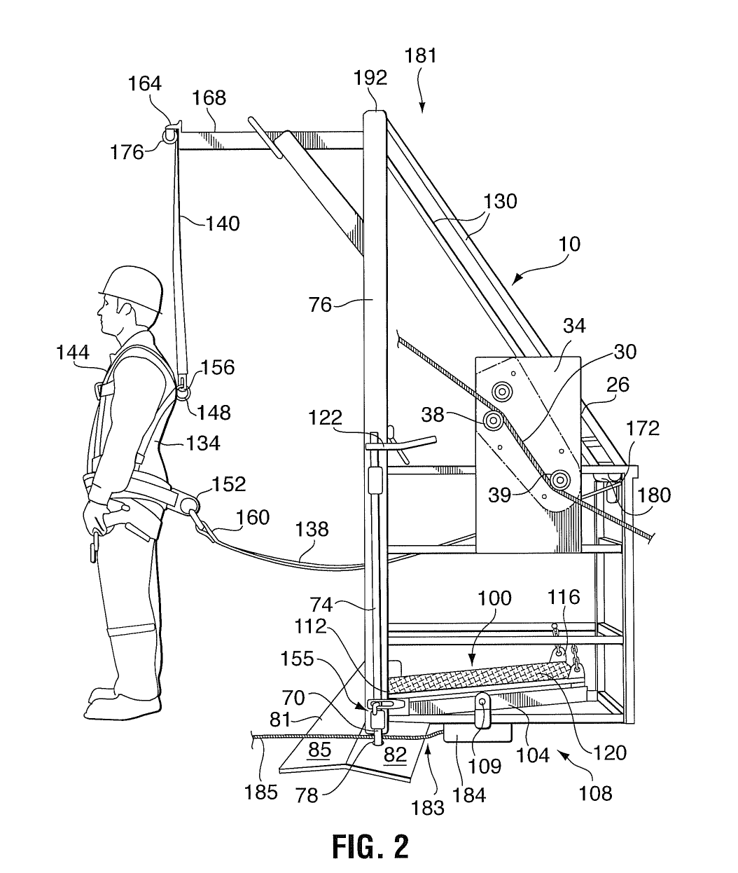

Referring for instance to the example embodiment illustrated in FIG. 2, the lanyards 138 and 140 are connected to the escape apparatus 10 rather than the platform 18. The impact of this modified setup is that a rig worker in an accident situation does not need to spend time and effort disconnecting any of the previously described lanyards as there are no lanyards connecting the worker to the platform 18. A further impact of the illustrated setup is that the rig worker saves additional time that would normally be taken in connecting one or more lanyards extending between himself and the escape apparatus (because one or more lanyards are already so connected). Thus the lanyards 140 and 138 are multi-purpose. Firstly, when the rig worker is standing on the floor 22 of the platform 18, the lanyards 138 and 140 prevent an accidental free fall off of the platform 18. Secondly, when the rig worker is within the trolley 10, the lanyards 138 and 140 prevent an accidental free fall out of the trolley 10. Also, it will be understood that although lanyards are the linking means shown in FIGS. 2, 3, and 4, other suitable linking means are possible such as non-lanyard ropes, cables, chains, or any suitable combination or splicing of linking means.

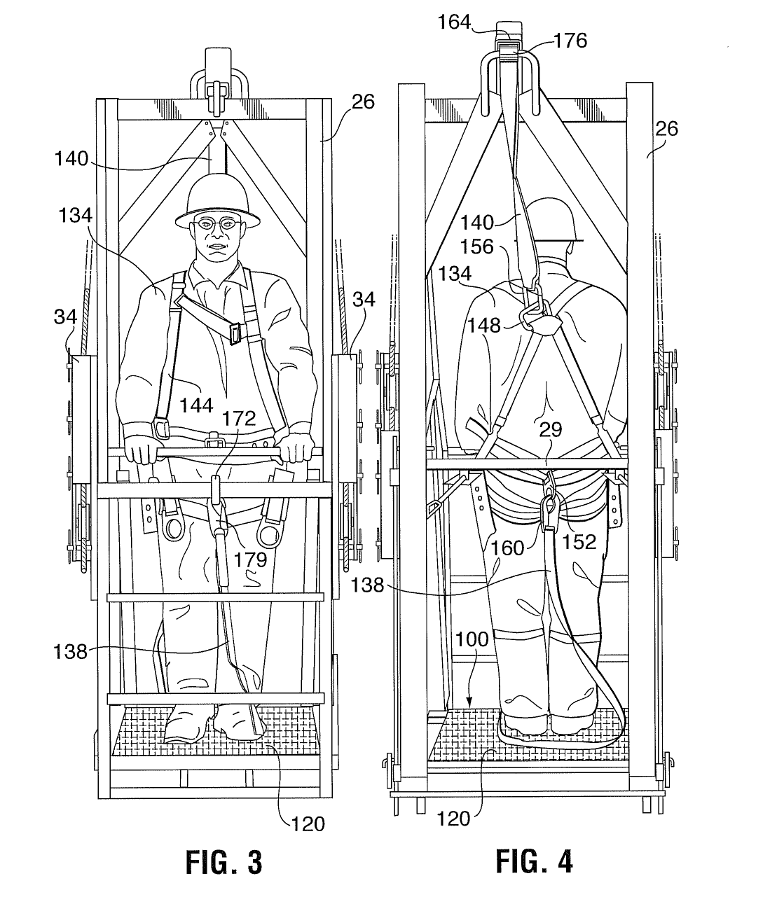

In a number of exemplary embodiments, shackles 156 and 160 at ends of the lanyards attach to a set of belts 144 at rings 148 and 152 respectively (these rings hang off of the set of belts 144) while the other ends of the lanyards 140 and 138 are respectively attached at jutting end 164 of overhang member 168 and at a frame location 172 at the back of the trolley 10. As seen in FIG. 2, for example, the overhang member 168 is adapted to extend into the region of the platform 18 when the trolley 10 is positioned next to the platform 18 so that the end 164 of the overhang member 168 is close to any rig worker who might be standing on the floor 22 of the platform 18. Alternative points of attachment for the end of the lanyard 140 are possible. If there is no overhang member 168, attachment of the lanyard end can be, for example, at frame apex 192 (FIG. 2). Reels 176 and 180 are used to vary the slack of the lanyards 140 and 138. It will be understood that the reels 176 and 180 are optional. In the example embodiment illustrated in FIG. 3, for instance, there is a shackle 179 at frame-connecting end of the lanyard 138 (instead of the reel 180).

During its descent down and away from the platform 18, the trolley 10 moves away from a start location at the platform 18 that is associated with worker loading, to a terminal location associated with worker unloading by travel along at least one path-defining cable. In the example embodiment illustrated in FIG. 1, there are two path-defining cables 30; however the number of cables used may vary. For example, in some example embodiments four, three or even only one cable might be used. In some example embodiments, the use of more than one cable may permit a more stabilized descent and may simplify setup and locking of the trolley against the platform at the time the trolley is brought to the start position and made available to be used when needed. In at least one example, the cables used are 9/16″ diameter steel cables, although it is to be understood that any diameter can be used, as long as chosen using sound engineering judgment.

As can be seen in FIG. 1, one end of each of the cables 30 are hooked up to the platform 18. In at least some examples, this upper point of attachment is several feet above the floor 22. The other ends of the cables 30 are anchored with ground anchors 33 (FIG. 1) to the ground at a location safely distant from the platform 18, for instance at location 32 which in some examples is horizontally distanced about 80 to 100 feet from the platform 18. In some examples, the ground anchors 33 are screwed in anchors that have been pull tested. In at least one alternative example, a portable anchor secured by the weight of a vehicle is used instead of a ground anchor.

The illustrated trolley 10 includes a pair of pulley assemblies 34 for cammed movement. In the Figures, the pulley assemblies 34 are mounted and attached on the sides of the frame 26 at a height between top 181 and bottom 183 of the frame 26, thereby permitting the centre of gravity of any worker riding in the trolley 10 to be below the pulley assemblies 34. In FIG. 2, one of the pulley assemblies 34 is shown with sheave cover 36 removed. As shown in FIG. 2, each of the pulley assemblies 34 includes two sheaves 38 and 39, each having a peripheral surface in contact with one of the cables 30. It will be understood that alternative examples wherein a different number of sheaves are employed is contemplated. Furthermore, although in the illustrated example embodiment the cable 30 passes directly over the top of the sheave 38 and directly under the bottom of the sheave 39, those skilled in the art will appreciate that other cable engagement configurations are possible.

It will be understood that the trolley 10 could be brought up from the ground to the start location at the platform 18 by one of a number of different methods. If the trolley 10 is brought to the terminal location and put onto the cables 30, a winch (not illustrated) could be used to pull the trolley 10 up to the start location. Alternatively, a conventional crane or some other suitable lifting device could be used to lift the trolley to the start location at the platform 18.

Once the trolley 10 is brought up against the platform 18, a releasable locking system is employed to hold the trolley 10 in position against the platform 18, until the trolley is required for lowering a worker from the platform. A locking system in accordance with at least one example embodiment is illustrated in FIG. 2. Locking mechanism 155 of the illustrated locking system includes a locking pin 70 at a lower end of a rod 74 that is vertically displaceable and located adjacent an upright frame member 76 of the frame 26. Once positioned over locking pin hole 78, the pin 70 is dropped into and extends through locking the pin hole 78 defined in locking plate 82. It will be understood that the weight of the rod 74 and lateral forces caused by gravitational influence on the trolley 10 help maintain the position of the locking pin 70 within the locking pin hole 78. Optionally, a latch or some other releasable locking mechanism could be used to further ensure that the locking pin 70 is kept in the locking position. For example, a latch could be used to restrict vertical displacement of the rod 74 when the trolley 10 is not being used. In some example embodiments, more than one vertically displaceable rod is employed. For instance, in one example embodiment there is a second rod adjacent the other of the two vertically extending frame members at the entrance/exit trolley end. In such an example embodiment there would be two locking pin holes in the locking plate 82, each receiving one locking pin.

Although a locking pin hole is the mating portion on the platform 18 of the illustrated example embodiment, it will be understood that other arrangements of mating parts are contemplated. For example, the mating portion on the platform 18 could be a male mating part rather than a female mating part. It will be appreciated that one skilled in the art would be able to carry out this type of a modification without undue effort, and that such a modification would not in and of itself have a material effect on the way the locking system works.

The locking plate 82 is joined to an adjacent plate 85 by suitable means such as by welding, for example. (Alternatively, the plates 82 and 85 could, for example, be a single plate bent along edge 81.) The illustrated locking plate 82 is downwardly angled from the adjacent plate 85; however in some examples the locking plate 82 could extend out horizontally instead of being downwardly angled. Also, in some examples the locking plate 82 could be a hinged plate (e.g. hinged along the edge 81). An impact of employing a hinged plate would be the ability to vary the angle of the locking plate depending upon the trolley employed and also the angle of trolley descent from the start location at the platform. In some example embodiments, the plate 85 is attached to beam 83 of the platforn 18 (FIG. 1) during assembly of the platform 18.

In at least a number of example embodiments, the locking system of the escape apparatus includes a foot-actuated disengager for releasing the frame 26 of the escape apparatus from a locked state so that the frame 26 is free to descend down and away from the platform 18 under the influence of gravity. The foot-actuated disengager that is illustrated is a pivoting plate disengager 100. This disengager 100 includes a rectangular frame 104, two sides of which are attached to floor section 108 at hinge 109 (at a bottom of the frame 26). In at least one example, the hinge attachment is at least relatively close to the midpoint between ends 112 and 116 of the disengager 100. Attachment as shown is analogous to the attachment of a beam to a centre support when a playground seesaw is assembled.

The disengager 100 also includes a plate 120 attached to its frame 104 and adapted to be stood upon (or stepped on) by a rig worker after he enters into the trolley 10. The illustrated disengager 100 is such that when no weight is placed on the plate 120, the end 116 is in a raised position relative to the end 112 (i.e. the end 116 is higher than the end 112). Conversely, when a rig worker stands on a foot receiving surface region of the plate 120 sufficiently close to the end 116, the weight applied by the worker downwardly on the disengager 100 causes the end 116 to descend while the end 112 rises in a manner analogous to the motion of a seesaw.

The rod 74 is (in a number of examples) hooked onto the disengager 100 at a location proximate to the end 112. In some alternative examples, the rod 74 is rigidly linked to the end 112 in some other manner than being hooked. For instance, a vice-type gripping mechanism could be employed. Because the end 112 is rigidly linked to the rod 74, when the end 112 is caused to rise by the rig worker standing on the plate 120, so too is the rod 74 caused to rise. Because the pin 70 is integral (or alternatively rigidly linked in some other manner) to the rod 74, the pin 70 undergoes the same upward movement that occurs in relation to the rod 74. Removal of the locking pin 70 from the locking pin hole 78 is effected by upward movement of the pin 70. Thus, it will be understood that the locking pin 70 is moved in or out of locking position by lowering or raising (respectively) of the rod 74. Also, the rod 74 can be raised by pulling on it by means of an optional handle 122, or without the use of the handle 122 by gripping on the shaft of the rod 74 itself.

When the locking pin 70 has risen out of the locking pin hole 78, the locking mechanism 155 is disengaged from the mating portion and the trolley 10 is free to travel down and away from the platform 18 under the influence of gravity. In at least some embodiments, one or more braking devices are used to prevent the falling trolley from entering a rapid, uncontrolled descent. Referring for instance to the example embodiment illustrated in FIG. 1, an automatic braking device 184 is attached at the bottom of the trolley 10, beneath the disengager 100. In at least one example, as the trolley 10 descends the braking device 184 gradually lets out length of a cable lanyard 185 anchored to the underside of the floor 22 of the platform 18. Descent can be quick but still slowed down to prevent an excessively forceful impact when the trolley 10 arrives at the ground or other terminal location.

In at least one example, the braking device 184 that is employed is the Rollgliss® Rescue Emergency Descent Device model no. 3303001, which is manufactured by DBI/SALA & Protecta. For sloped descent applications, a half inch diameter guide cable is normally used in conjunction with the Rollgliss® device; however this guide cable is not needed for the sloped descent application herein disclosed because the trolley 10 is suitably guided by the cables 30 that extend between the platform 18 and the terminal location 32. Using the Rollgliss® device, a controlled descent rate of 15 feet/second or greater can be achieved. If the Rollgliss® device is employed, it will dictate the weight capacity of the trolley 10. For example, if the Rollgliss® device is rated to support up to 230 kg (506 lbs), and if, for example, the trolley 10 weighs 105 kg (231 lbs), then the recommended maximum amount of person and cargo weight for loading into the trolley 10 would be 125 kg (275 lbs). It will be understood that in some examples weight capacity of the trolley will be dictated by some other factor or factors besides the weight rating for the braking device 184. For instance, in at least one example the weight capacity of the trolley will be limited by the strength of the anchoring at the terminal location 32.

It will be understood that alternative braking systems besides those employing the illustrated braking device 184 are contemplated. For example, known braking systems that employ hand actuated levers (including those for overriding automatic braking settings) are contemplated. Also, one skilled in the art will appreciate that the braking device 184 need not be attached at the bottom of the trolley 10, but could be attached at a higher location; however attachment of the braking device 184 to the top of the trolley 10, for example, could have the effect of making the trolley 10 more top heavy.

In some examples, lighting will be provided at the egress 14 and/or the terminal location 32. This lighting may improve visibility for the escaping worker, especially when the escape apparatus is used during non-daylight hours.

Certain adaptations and modifications of the described embodiments can be made. Therefore, the above discussed embodiments are considered to be illustrative and not restrictive.

At least one embodiment has been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

What is claimed is:

1. An apparatus for emergency escape from a drilling rig platform along a path defined by at least one cable extending between the platform and a remote, terminal location, the apparatus comprising:
a frame in which a top of said frame is located above a bottom of said frame when said frame is erect, said frame defining an interior space large enough to accommodate an associated worker; and,
a locking system including a locking mechanism and a foot-actuated disengager that is located at least proximate said bottom of said frame,
said locking mechanism adapted to interlock with a mating portion on said platform to prevent said frame from traveling away from said platform when said locking mechanism engages said mating portion,
said disengager connected to said locking mechanism and having a foot receiving surface region upon which force can be applied to displace said disengager between a first, engaged position and a second position to disengage said locking mechanism from said mating portion,
wherein said frame will travel away from said platform to the terminal location under gravity when said locking mechanism is disengaged.

2. The apparatus as claimed in claim 1 further comprising at least one pulley assembly mounted on said frame at a location above a midpoint between said top of the frame and said bottom of the frame, said pulley assembly configured for cammed movement along said cable.

3. The apparatus as claimed in claim 1 wherein said disengager is a pivoting plate disengager having opposite ends and opposite sides, each of said opposite sides pivotably attached to said bottom of the frame.

4. The apparatus as claimed in claim 3 wherein said locking mechanism is rigidly connected to one of said opposite ends and said foot receiving surface region is formed on a metal plate, said foot receiving surface region proximate to the other of said opposite ends.

5. The apparatus as claimed in claim 4 wherein said pivoting plate is constructed so that a downward force on one portion of said pivoting plate causes disengagement of said locking mechanism, and said first and second positions correspond to the other of said opposite ends being raised and depressed, respectively.

6. The apparatus as claimed in claim 3 wherein said locking system further includes a vertically displaceable rod and a locking pin, said locking pin at a bottom end of said rod and said rod being rigidly connected to one of said opposite ends, and said rod being upwardly displaced when said disengager is moved from said first position to said second position.

7. The apparatus as claimed in claim 1 further comprising a pair of cables and a pair of pulley assemblies spaced apart from each other and evenly mounted on opposite sides of said frame at locations above said bottom of the frame, said pulley assemblies configured for cammed movement along said cables.

8. The apparatus as claimed in claim 1 wherein said locking mechanism includes a locking pin and said mating portion is a locking pin hole defined in a locking plate of said platform.

9. The apparatus as claimed in claim 1 wherein said frame further comprises an overhang member extending out horizontally from a platform-facing side of said frame, said overhang member having a jutting end adapted to receive a lanyard reel.

10. The apparatus as claimed in claim 9 further comprising a lanyard downwardly hanging from said jutting end and a lanyard reel attached to said jutting end for varying slack of said lanyard.

11. The apparatus as claimed in claim 10 further comprising another lanyard attached at a different location on said frame.

12. The apparatus as claimed in claim 1 wherein said disengager is activated to disengage said locking mechanism from said mating portion when said worker stands on said foot receiving surface.

13. An apparatus for emergency escape from a drilling rig platform along a path defined by at least one cable extending between the platform and a remote, terminal location, the apparatus comprising:
a frame in which a top of said frame is located above a bottom of said frame when said frame is erect, said frame defining an interior space large enough to accommodate an associated worker;
a locking means adapted to interlock with a mating means on said platform to prevent said frame from traveling away from said platform when said locking means engages said mating means; and
a foot-actuated disengagement means located at least proximate said bottom of the frame, said foot-actuated disengagement means connected to said locking means and having a foot receiving surface region upon which force can be applied to displace said foot-actuated disengagement means between a first engaged position and a second position to disengage said locking means from said mating means,
wherein said frame will travel away from said platform to the terminal location under gravity when said locking means is disengaged.

14. The apparatus as claimed in claim 13 further comprising a pair of cables and a pair of pulley assemblies spaced apart from each other and evenly mounted on opposite sides of said frame at locations above a midpoint between said top of the frame and said bottom of the frame, said pulley assemblies configured for cammed movement along said cables.

15. The apparatus as claimed in claim 13 wherein said locking means includes a locking pin and said mating means is a locking pin hole defined in a locking plate of said platform.

16. The apparatus as claimed in claim 13 wherein said frame further comprises an overhang member extending out horizontally from a platform-facing side of said frame, said overhang member having a jutting end adapted to receive a lanyard reel.

17. The apparatus as claimed in claim 13 wherein said disengagement means is activated to disengage said locking means from said mating means when said worker stands on said foot receiving surface.
